(19) United States
(12) Patent Application Publication
(10) Pub. No.: US 2011/0167958 A1
(43) Pub. Date: Jul. 14, 2011

(54) ELECTRIC MOTOR ACTUATING DRIVE

(75) Inventor: Herbert MOELLER, Bad Oeynhausen (DE)

(73) Assignee: ABB Technology AG, Zurich (CH)

(21) Appl. No.: 12/986,354

(22) Filed: Jan. 7, 2011

(30) Foreign Application Priority Data
Jan. 8, 2010 (DE) 202010000709.7

(51) Int. Cl. F16H 1/02

(52) U.S. Cl. 74/724; 74/665 A

(57) ABSTRACT

Exemplary embodiments are directed to an actuating drive. The actuating drive includes an electric motor that is operatively connected to a fitting via a device unit and a transmission unit that is equipped with a manual device. The drive unit combines functional units of the manual drive, the brake, the manual drive and a displacement feedback of the brake in an attachable housing.

### RELATED APPLICATION

This application claims priority under 35 U.S.C. §119 to German Patent Application No. 202010000709.7 filed in Germany on Jan. 8, 2009, the entire content of which is hereby incorporated by reference in its entirety.

### FIELD

The disclosure relates to an electric-motor actuating drive, such as, an electric-motor actuating drive for controlling fittings for process automation.

In actuating drives for process automation, an electric motor drives a fitting, such as a valve, flap, slide or other functional unit as desired, via a transmission for matching the actuating movement and actuating time to the requirement. Actuating drives of this kind are equipped with a manual drive to operate the fitting in the event of power failure or damage to the electric motor.

### BACKGROUND INFORMATION

DE 42 39 947 and DE 27 58 443 discloses actuating drives for process automation that includes a transmission block, a drive motor, possibly a braking motor, a manual drive and a space for the displacement feedback. These functional units can be arranged on a specially designed transmission housing.

Because of the physical separation of the functional units, the specially desired transmission housings have many indentations and are therefore susceptible to soiling and vibration. Other transmission arrangements require external wiring, which is complex and susceptible to leakage.

### SUMMARY

An exemplary embodiment is directed to an actuating drive that includes an electric motor that is operatively connected to a fitting via a device unit and a transmission unit that is equipped with a manual device. The drive unit combines functional units of the manual drive, the brake, the manual drive and a displacement feedback of the brake in an attachable housing.

### BRIEF DESCRIPTION OF THE DRAWINGS

In the following exemplary embodiments of the invention will be described in greater detail with reference to the drawings, wherein:

FIG. 1 illustrates a drive unit in accordance with an exemplary embodiment; and

FIG. 2 illustrates an extended drive unit in accordance with an exemplary embodiment.

### DETAILED DESCRIPTION

The disclosure is based on known actuating drive in which an electric motor is operatively connected to a fitting via a transmission and which is equipped with a manual drive. The exemplary embodiments disclosed herein specify an electric-motor actuating drive that includes fewer components than a conventional actuating drive, is simple in design, and avoids the described drawbacks of known actuating drives.

In accordance with the exemplary embodiments of the present disclosure, a drive unit combines the functional units of the drive motor, the brake, the manual drive, and the displacement feedback in one housing. When assembled with a special or standard transmission, an actuating drive for operating a fitting is formed.

One housing integrates all the functional groups which are specified for operation of the actuating drive, which means that susceptible mechanical and electrical connections beyond housing boundaries are eliminated.

In an exemplary embodiment the output drive flange allows the drive unit to be attached to standardized step-down transmissions.

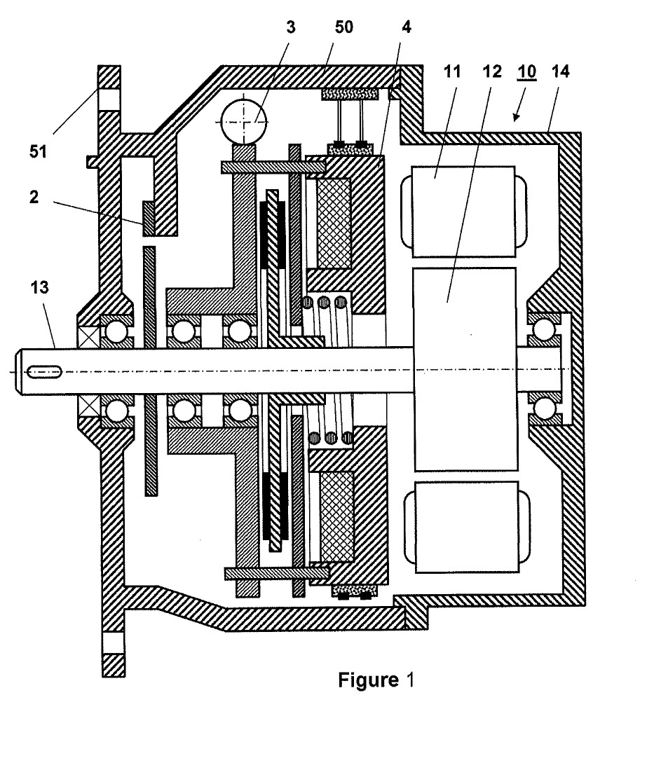

FIG. 1 illustrates a partially sectioned view of a drive unit in accordance with an exemplary embodiment of the present disclosure. The drive unit includes a drive motor 10, such as an enclosed motor, having a winding 11, a rotor 12, a motor shaft 13, and a housing cap 14. The housing cap 14 is connected to a housing 50. The housing 50 has a mounting flange 51, with dimensions that allow selectable attachment to different standard transmission sizes. As shown in FIG. 1, the motor shaft 13 can be operatively connected to the attached transmission.

In addition, the housing 50 accommodates a manual drive 3 with an integrated brake 4, as described in German patent application 10 2009 054 120.9. The manual drive 3 includes an inhibitory transmission, the output drive of which can be operatively connected for braking purposes to the motor shaft 13. As a result, force can be transmitted to the motor shaft B, via an electrically operatable, disengageable clutch.

The motor shaft 13 has a brake disc that is fixed in rotation and axially displaceable. The brake disc is arranged between the transmission wheel of the manual drive 3 and an armature disc of the electromagnetic brake 4. The armature disc is pushed in the direction of the transmission wheel by the force of a spring and is disengaged from the brake disc by virtue of the electromagnetic brake 4 being supplied with current.

In an exemplary embodiment, the housing 50 accommodates means for displacement feedback 2, as is known from the ABB Ontrac program.

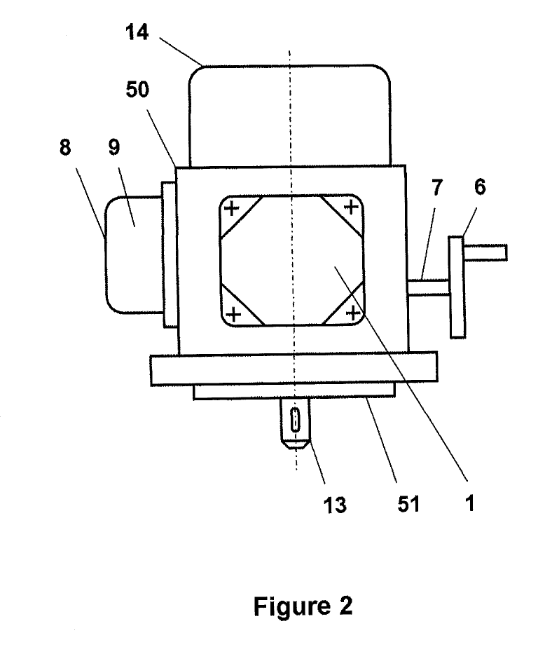

FIG. 2 illustrates an extended drive unit in accordance with an exemplary embodiment. The drive unit includes a housing 50 having a mounting flange 51 for attachment to a transmission from which the motor shaft 13 protrudes. On a side of the housing 50, which is remote from the mounting flange 51, the electric motor is accommodated beneath the housing cap 14.

The housing 50 has an electric connection 1 which is sealed by a cover. For the manual drive, a handwheel 6 is arranged on a handwheel shaft 7 which is routed into the housing 50. The drive unit has a control electronics unit 9 which is arranged beneath an electronics cowl 8.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Electric connection
2 Displacement feedback
3 Manual drive
4 Brake
6 Handwheel
7 Handwheel shaft
8 Electronics cowl
9 Control electronics
10 Drive motor
11 Winding
12 Rotor
13 Motor shaft
14 Housing cap
50 Basic housing
51 Mounting flange

What is claimed is:

1. An actuating drive, comprising:
an electric motor that is operatively connected to a fitting via a drive unit; and
a transmission that is equipped with a manual drive,
wherein the drive unit combines functional units of the manual drive, the brake, the manual drive, and displacement feedback of the brake in an attachable housing.

2. The actuating drive of claim 1,
wherein a control electronics unit and the electric connection for the control electronics unit are integrated in the attachable housing.

3. The actuating drive of claim 1,
wherein the manual drive includes an inhibitory transmission, the output drive of the inhibitory transmission can be operatively connected for braking purposes to the motor shaft, such that force can be transmitted, via an electrically operatable, disengageable clutch.

4. The actuating drive of claim 1,
wherein the transmission of the manual drive includes a worm-gear transmission stage.

5. The actuating drive of claim 1,
wherein the transmission of the manual drive has a blocking catch.
